(19) United States
(12) Patent Application Publication
(10) Pub. No.: US 2004/0058795 A1
(43) Pub. Date: Mar. 25, 2004

(54) Rotor for a centrifuge

(76) Inventor: Dieter Baumann, Greven-Gimbte (DE)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/668,996

(22) Filed: Sep. 23, 2003

(30) Foreign Application Priority Data
Sep. 23, 2002 (DE) 202 14 709.6

(51) Int. Cl. B04B 9/06; B04B 1/04

(52) U.S. Cl. 494/49; 494/74

(57) ABSTRACT

The invention relates to a rotor for a centrifuge intended for the separation of solid particles from a fluid, in particular from the lubricating oil of a Diesel combustion engine, with a rotor housing that is rotatable about a central rotational axis and cylindrical in its basic shape, wherein the rotor housing comprises a fluid inlet, a fluid outlet with one or more propulsion nozzles for driving the rotor by means of the fluid flowing through them, and walls that are provided in and partition the interior region of the rotor. The new rotor is characterized in that several wall pairs that are spaced apart from each other in a circumferential direction are provided in the interior rotor region, comprising walls that are also spaced apart from each other in a circumferential direction and enclose between them a space having the approximate shape of a gap, with the space radially extending in an outward direction from a central area that is connected to the fluid inlet and ending at a distance from or at a circumferential wall of the rotor housing, thus permitting fluid to enter into the remaining interior rotor region.

### BACKGROUND OF THE INVENTION

The present invention relates to a rotor for a centrifuge intended for the separation of solid particles from a fluid, in particular from the lubricating oil of a Diesel combustion engine, with a rotor housing that is rotatable about a central rotational axis and cylindrical in its basic shape, wherein said rotor housing comprises a fluid inlet, a fluid outlet in the form of one or more propulsion nozzles for driving the rotor by means of the fluid flowing through them, and walls that are provided in and partition the interior region of the rotor.

A first rotor of the above type is known from DE-U 200 12 392. In the case of this rotor, it is provided that the interior region of the rotor is partitioned in at least two concentric interior rotor spaces by at least one intermediate wall that is, in substance, arranged in the rotor concentrically with the circumferential wall of the rotor. Herein, walls extending in a radial direction can, in addition, be provided, with these walls being spaced apart in circumferential direction and also further partitioning the interior region of the rotor. Here, fluid can flow through the various interior spaces of the rotor either in parallel or in series. The use of this rotor in practice has shown that the substantial part of the dirt particles settle on the inner side of the circumferential wall of the rotor whereas, in relation thereto, only few dirt particles settle on the inner perimeter of the intermediate wall. As a result, the total dirt volume separated, despite the intermediate wall provided in the rotor, exceeds that separated in a conventional rotor without concentric intermediate wall to no substantial degree.

A further rotor is known from WO 98/46361 A1. In the case of this rotor, it is provided that it comprises at least one guide element that extends from an internal wall to an external wall of an interior rotor space. Preferably, several guide elements are provided in the form of radial walls distributed in circumferential direction and partioning the interior region of the rotor in several chambers that are distributed in the direction of the circumference of the rotor. This rotor provides only the internal surface of its circumferential wall for the settlement of dirt particles. Here, the guide elements merely ensure that the fluid present in the rotor is reliably set in rotation with the rotor and that the rotational speed of this fluid does not fall below the rotational speed of the rotor.

DT 25 04 371 A1 discloses a rotor for a centrifuge wherein a flat disk-shaped wall is provided in the interior of and parallel to the bottom of the rotor. The fluid to be purified is supplied through a central hollow axis and into the region between the bottom of the rotor and the disk-shaped wall arranged parallel thereto. The external perimeter of the disk, that amounts to approximately half the radius of the rotor, is formed to comprise a collar-shaped wall that is angled in the direction of the bottom and, in cooperation with the bottom, forms a full-perimeter passage gap. The purpose of this disk is to prevent the fluid to be purified from flowing away to the propulsion nozzles in the quickest way possible.

EP 0 806 985 B1 discloses a rotor that comprises a stack of inserts in its interior region that have the shape of the circumferential surface of a truncated cone. In this manner, it is ensured that the fluid to be purified, after having entered into the rotor, is initially directed outwardly in a radial direction and can only thereafter reach the outlet through the intermediate spaces between the inserts that have the shape of the circumferential surface of a truncated cone and are arranged on top of each other. Although this causes the complete fluid volume to be supplied to a point near the external perimeter of the rotor where the strongest centrifugal forces are acting, the manufacture and assembly of rotors of this type are very complex and expensive, owing to the large number of insert parts that have the shape of the circumferential surface of a truncated cone which must be mounted on top of each other.

### SUMMARY OF THE INVENTION

Therefore, the present invention aims at creating a rotor of the aforementioned type wherein, on the one hand, a high efficiency with a good degree of separation and, on the other hand, a relatively simple design and a cost-effective productibility can be achieved. This problem is solved by the invention by a rotor of the aforementioned type, characterized in that several wall pairs that are spaced apart from each other in a circumferential direction are provided in the interior rotor region, comprising walls that are also spaced apart from each other in a circumferential direction and enclose between them a space having the approximate shape of a gap, with said space radially extending in an outward direction from a central area that is connected to the fluid inlet and ending at or at a distance from a circumferential wall of the rotor housing, thus permitting fluid to enter into the remaining interior rotor region.

The rotor according to the invention ensures, to its advantage, that the fluid to be purified, after having entered into the rotor housing, is directed through the gap-shaped spaces that are enclosed by the wall pairs, initially in a radially outward direction, thus entering a region of high centrifugal force that is proportionate to the radius of the rotor. Only in this radially outer region of the rotor can the fluid be transferred to the remaining interior region of the rotor. Depending on the form of the rotor, the settlement of dirt can be achieved at the internal perimeter of the circumferential wall of the rotor as well as, at least in part, already in the radially outer region of the gap-shaped spaces. This ensures that the fluid to be purified is safely prevented from reaching the outlet of the rotor in a quick way with only low centrifugal forces being exerted on it and without any noticeable separation of dirt particles. In this manner, it is ensured that the rotor has a high efficiency. At the same time, the construction of the rotor is still relatively simple, because guiding the fluid from the inlet into the region near the circumferential wall of the rotor housing requires only several wall pairs that do not have to be shaped in a complicated manner and that can, thus, be produced and integrated in the interior region of the rotor in a comparatively simple and cost-effective manner.

Furthermore, it is preferably provided that the wall pairs forming the walls extend along planes that are, in substance, arranged in parallel with the rotational axis or extend, in substance, in a radially outward direction. With this wall alignment, the distances to be covered by the fluid to be purified from the inlet into the radially outer region are, to their advantage, short and straight, thus keeping undesired flow resistances low.

Moreover, the invention proposes that the spaces having the shape of a gap form a rotationally symmetric star shape, as seen from a cross-sectional view of the rotor. This ensures that the fluid to be purified is supplied to the rotor such that it is uniformly distributed over the perimeter of the rotor, thus causing a dirt settlement that is, accordingly, distributed in a likewise uniform manner. As a consequence, any problems caused by imbalances of the rotor that is rotating at high speed are prevented.

In a further embodiment, it is proposed that the star shape is formed to comprise three to eight arms, preferably four to six arms. This ensures, on the one hand, that the distribution is as uniform as desired and, on the other hand, that the cost for producing the walls for the wall pairs remains within reasonable limits.

It is further provided that at least one of the two walls of each wall pair is formed to comprise a front wall section that forms a partial and radially outer boundary of the respectively enclosed gap-shaped space and extends, in substance, in a circumferential direction. Such a front wall section provides a surface for settlement of the dirt particles from the fluid to be purified, as early as in the region of each gap-shaped space that is enclosed by the walls of the wall pairs. Hence, particles can already be preseparated in this region; the further separation of dirt particles is then achieved at the internal perimeter of the circumferential wall of the rotor that is reached by the fluid to be purified after it has exited from the gap-shaped spaces. It is, hence, altogether feasible to expect quicker and better filling of the rotor with dirt particles because additional dirt settlement surfaces are provided.

A first further development of the embodiment described above proposes that each front wall section partially delimits the space in the direction of the circumference of the rotor. This then results in a fluid transfer from the gap-shaped space into the remaining interior region of the rotor in the form of a narrower gap or slot that extends in parallel with the rotational axis and is delimited by the front wall section or the front wall sections.

As an alternative, each front wall section can partially delimit the space in the direction of the axis of the rotor. In this case, the fluid transfer thus extends from the gap-shaped space into the remaining interior region of the rotor across a part of the height of the gap-shaped space. Across the remaining gap-shaped space height that is delimited by the front wall section, the front wall section can be used as a settlement surface for dirt particles.

A further embodiment of the rotor proposes that the two walls of each wall pair are connected to each other via a front wall that extends, in substance, in a circumferential direction and forms a radially outer boundary of the respectively enclosed gap-shaped space that ends at a distance from the circumferential wall and that a fluid transfer opening is provided in the front wall and/or in at least one wall of the wall pair. In this exemplary form, the size of the front wall is the maximum possible size, so that it also provides an additional dirt particle settlement surface of the maximum possible size. Here, the fluid transfer opening can be realized in different executive forms and at different places.

It is further preferably provided that the radial distance of the front wall section or the front wall from the rotational axis of the rotor each amounts to about 70 to 90 percent of the rotor radius. This ensures that relatively high centrifugal forces are acting as early as in the region of the front wall sections or the front walls, wherein these centrifugal forces produce an efficient settlement of dirt particles on these front wall sections or front walls that form a radially outer boundary as early as in the region of the gap-shaped spaces.

To ensure that, with the rotor rotating, the fluid present in the rotor follows the rotation of the rotor in a non-slip manner, one wall of each wall pair each extends to the internal perimeter of the circumferential wall of the rotor housing. The walls extending to the internal perimeter of the circumferential wall each ensure that, with the rotor rotating, the fluid present in the interior region of the rotor is carried along in an efficient manner, whereby the centrifugal forces take a maximum effect within the fluid.

In a further embodiment, the invention proposes that the wall extending to the internal perimeter of the circumferential wall of the rotor housing each is the wall that advances in the direction of rotation of the rotor. Hence, the fluid transfer from the space enclosed between the walls of the wall pairs takes place behind the respective advancing wall, as viewed in the direction of rotation of the rotor, this being of advantage to the flow path of the fluid.

A further exemplary form of the rotor is characterized in that the two walls of each wall pair extend to the internal perimeter of the circumferential wall of the rotor housing and that a fluid transfer opening is provided in at least one of the walls of the wall pair. In this executive form, the spaces enclosed by the walls of the wall pairs extend in a radial direction as far outwardly as possible. As a consequence, the maximum possible centrifugal force in the rotor is also acting in the gap-shaped spaces. Here, it is likewise ensured that the fluid is carried along with the rotation of the rotor.

For each of the fluid transfer openings that are directed from the enclosed space into the remaining interior region of the rotor, it is preferably provided that each fluid transfer opening extends as a slot across a radial region, preferably a radially outer region, of a wall of the wall pair and/or, if necessary, across the front wall. In this form, the fluid transfer opening can be manufactured easily and provides a flow cross-section that is sufficient in size. Preferably, the slot is formed at the top edge of the wall by a minor shortening of the wall and is limited in upward direction by an upper wall of the rotor housing, this resulting in a particularly simple construction.

A further embodiment preferably provides that the width of the slot forming the fluid transfer opening decreases from the exterior to the interior in a radial direction. This embodiment ensures that, with dirt particles increasingly settling at the internal perimeter of the circumferential wall of the rotor, the fluid is reliably transferred even if the fluid transfer opening is, in part, covered by the settled dirt particles. This is achieved by the fact that the flow rate of the fluid flowing through the remaining narrower region of the fluid transfer opening is increased such that, here, a passage is always cleared. This excludes a complete blockage of the fluid flow through the rotor to the highest degree possible.

As regards the alignment of the walls of the wall pairs in relation to one another, it is preferably provided that the walls of each wall pair are each aligned either in parallel with one another or are converging in a radially outward direction or diverging in a radially outward direction. Here, the selection is appropriately made according to the flow conditions and settlement surface sizes desired and according to technical production aspects.

In order to provide an increased region for settlement of dirt particles in each radially outer region of the spaces enclosed between the walls of the wall pairs, an embodiment of the rotor provides that, in their radially outer part, the walls of each wall pair each comprise a lateral curved projection each extending away from the other wall of the wall pair in a circumferential direction and intended to increase the size of the front wall as measured in circumferential direction.

It is further preferably provided that the rotor comprises a central tube extending concentrically with its rotational axis, wherein said central tube is provided as a fluid inlet to the interior rotor region and is in fluid communication with the spaces respectively enclosed by the wall pairs via apertures. This also permits the rotor according to the invention to provide the fluid supply through the central tube in a manner that is usual and known as such, and the rotor according to the invention can be inserted in a centrifuge in the stead of a conventional rotor without any problems, without any other modifications to the centrifuge being necessary.

In order to ensure that the fluid to be purified enters into the spaces enclosed by the walls of the wall pairs in a radially outward direction as far away from the rotational axis of the rotor as possible, it is further proposed that a fluid channel is formed inside a lower area of each space, that is extending from the apertures into a radially central to outer area of said space.

In order to ensure a low-resistance flow area of sufficient size when the fluid is flowing through the spaces enclosed by the walls of the wall pairs, it is further provided that the wall pairs, as viewed in the direction of the axis of the rotor, each extend across at least half of its axial internal height and, at the most, across its total axial internal height.

While the rotor is in operation, the centrifugal force causes the dirt particles present in the fluid to migrate in a radially outward direction. For that reason, it is appropriate to withdraw the fluid from the rotor in a region that is radially located as far inward as possible and to direct said fluid to the fluid outlet. To ensure that the fluid is directed in this manner, it is preferably provided that an intermediate wall extending, in substance, in a circumferential direction and ending at a distance from the inner side of an upper wall of the rotor housing is each arranged between two walls of two neighboring wall pairs, wherein the said two walls are facing each other, and the said intermediate wall, together with the walls of the wall pairs, forms a radially inner channel that is running to the fluid outlet in the direction of the axis of the rotor. Moreover, the additional effort required to form the channels running to the fluid outlet is only little, because the channels are, to a major part, delimited by the anyhow existing walls of the wall pairs; a smaller part of the boundary of the channels is formed by the additionally provided intermediate walls.

In order to direct the fluid flowing from the spaces enclosed by the walls of the wall pairs into the remaining interior region of the rotor through the fluid transfer openings in a forcing manner into a region of high centrifugal force, the invention proposes that a flow guide wall is provided next to each fluid transfer opening on the outside of each associated wall of the wall pair, wherein the flow of fluid coming from the fluid transfer opening can be directed through said flow guide wall either in a radially outward direction or in a radially outward and axially downward direction. For example, the flow guide wall may have the form of a curved wing that is attached to the outside, that is to say to that side of one of the walls of the respective wall pair that is facing away from the enclosed space. It is also possible to form the flow guide wall integrally with the pertinent wall.

It is further preferably provided that the diameter of the rotor exceeds the latter's height. At a specified volume and speed of the rotor, this configuration of the rotor geometry permits to achieve, in particular, a centrifugal force acting on the dirt particles in the interior region of the rotor that is higher than that in a rotor of normal geometry, where the diameter of the rotor is smaller than the rotor height.

In order to achieve cost-effective manufacturing of the rotor, an executive form provides that at least the several wall pairs are made of a single-piece injection-molded part of plastic or light metal and inserted in the rotor housing as an insert. The production of large piece numbers of such an insert is cost-effective, and such an insert can be installed as a unit in the interior region of the rotor housing during production of the rotor in a quick and easy manner.

An embodiment of the rotor that is an alternative in this regard is characterized in that the rotor housing comprises one injection-molded lower housing part and one injection-molded upper housing part and that a first part of the walls of the several wall pairs is formed integrally with the lower housing part and a second part of the walls of the several wall pairs is formed integrally with the upper housing part. In this executive form, the rotor preferably comprises only two substantial assemblies that can each be produced as such and can then be assembled to form the complete rotor housing including the walls provided therein.

In a third exemplary form in this connection, it is provided that the rotor housing comprises one injection-molded lower housing part, interior housing part and upper housing part each and that the walls of the several wall pairs are, as a whole or in part, formed integrally with the lower housing part and/or the interior housing part and/or the upper housing part. In this executive form, the rotor housing including the parts contained therein comprises three assemblies, thus particularly permitting the production of rotors with two bottoms. For example, one or more nozzle chambers that are arranged upstream of the propulsion nozzles for driving the rotor can be provided between the bottoms.

### BRIEF DESCRIPTION OF THE DRAWING

Executive examples of the invention will be illustrated below by means of a drawing, wherein

FIG. 1 is a top elevational view of a rotor in a first executive form with omitted upper rotor wall.

FIG. 2 is a cross-sectional view of the rotor of FIG. 1 along line II-II in FIG. 1.

FIG. 3 shows an insert installed in the rotor housing of the rotor according to FIGS. 1 and 2 in an inclined perspective from below, without the rotor housing.

FIG. 4 shows the rotor in a second exemplary form in the upper half and the rotor in a third exemplary form in the lower half, each in a top elevational view according to the representation in FIG. 1.

FIG. 5 shows the rotor in a forth exemplary form in its upper half and the rotor in a fifth exemplary form in its lower half, each represented in the same way as in FIG. 1 and FIG. 4.

### DETAILED DESCRIPTION OF THE PREFERRED EMBODIMENT

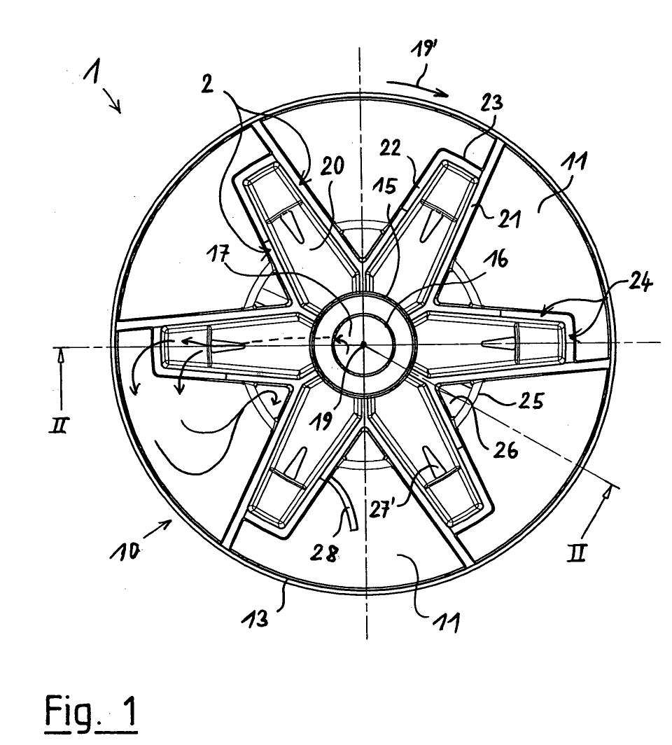

As shown in FIG. 1 of the drawing, the first embodiment of a rotor 1 that is represented here comprises a rotor housing 10 that encloses an interior rotor region 11. The rotor housing 10 comprises a bottom that is not visible in FIG. 1, a circumferential wall 13 and an upper wall that has been omitted in FIG. 1 to allow a view inside the interior region of the rotor 1.

The rotor 1 can be rotated about a central rotational axis 19 in the direction of rotation indicated by the arrow 19′, here by means of propulsion nozzles arranged below the non-visible bottom, as is known in general. A central tube 15 extends concentrically with the rotational axis 19, with an upper plain bearing 16 and a lower plain bearing that is not shown here and is provided for rotatably bearing the rotor 1 on an axis in a centrifuge housing that is not shown here being arranged in said central tube. The hollow interior region of the central tube 15 forms a fluid inlet 17 through which a fluid to be purified, for example the lubricating oil of a Diesel combustion engine, is supplied to the rotor 1 from below.

Starting from a central region of the rotor housing 10, several wall pairs 2, here a total of six, extend in an outward direction, with said wall pairs being each formed by two walls 21, 22 that extend perpendicular to the plane of the drawing. The walls 21, 22 each enclose a space 20 having the approximate form of a gap and extending in an outward direction from the central region of the rotor housing 10 to a relatively small distance from the internal perimeter of the circumferential wall 13. Here, the spaces 20 are each closed by a front wall 23 in the radially outer region, with the front walls 23 extending parallel to and at a distance from the circumferential wall 13 of the rotor housing 10 and formed integrally with the walls 21, 22. The first walls 23 are positioned a distance from the circumferential wall 13 which is a small fraction, that is, less than ½, of the radius of the rotor housing 10. One wall 21 of each wall pair 2 is extended beyond the pertinent front wall 21 to the internal perimeter of the circumferential wall 13.

As mentioned above, spaces 20 are delimited by the walls 21, 22 and the front walls 23. The wall pairs 2 and the wall 21 each extending to the circumferential wall 13 partition the interior region 11 of the rotor housing 10 in several, here six, chambers in a circumferential direction.

While the rotor 1 is operated in a centrifuge, fluid to be purified flows into the rotor through the fluid inlet 17 from below. The fluid flows in a radially outward direction through openings that are not shown here and through a concealed channel in each of the lower regions of the spaces 20 where it enters into the pertinent space 20 through the visible passages 27′ in an upward and radially outward direction. Herein, the passages 27′ within the spaces 20 are arranged relatively far to the outside, so that the fluid and the dirt particles contained therein are already subjected to a considerable centrifugal force.

The surface of the front walls 23 that is arranged in a radially inward direction forms a first settlement surface for dirt particles from the fluid that, owing to the centrifugal force, migrate in a radially outward direction and settle on the front wall 23. The fluid that has been prepurified in this manner is then transferred into the remaining interior region 11 of the rotor housing 10 via fluid transfer openings 24. In the embodiment according to FIG. 1, the fluid transfer openings 24 are formed as slots that are arranged at the upper edge of the walls 22 and the front walls 23 and are, at their top, delimited by the upper wall of the rotor housing 10 that is not shown here. The fluid transfer openings 24 are, in turn, also arranged in a radially outer region of the wall pairs 2 so that the fluid being transferred enters into a radially outer region of the interior region 11 of the rotor housing 10. Here, a considerable centrifugal force is further acting upon the dirt particles in the fluid, thus causing the dirt particles to settle on the inner surface of the circumferential wall 13.

In order to support the flow path of the fluid flowing out of the fluid transfer openings 24 in a radially outward direction, the walls 22 can each be provided with a flow guide wall 28, as indicated, for example, by the wall 22 in FIG. 1 that extends to the lower left.

Finally, the purified fluid flows through a channel 26 that is arranged further inwardly in radial direction to a fluid outlet that is not visible here. This channel 26 is each provided between two neighboring walls 21, 22 of two neighboring wall pairs 2 and is each delimited in a radially outward direction by an intermediate wall 25. All intermediate walls 25 are arranged on a common circular line that extends concentrically with the rotational axis 19. The flow conditions described are illustrated by flow arrows in the left-hand part of the interior rotor region 11. The appropriate flows are also developing in the other chambers of the interior rotor region 11.

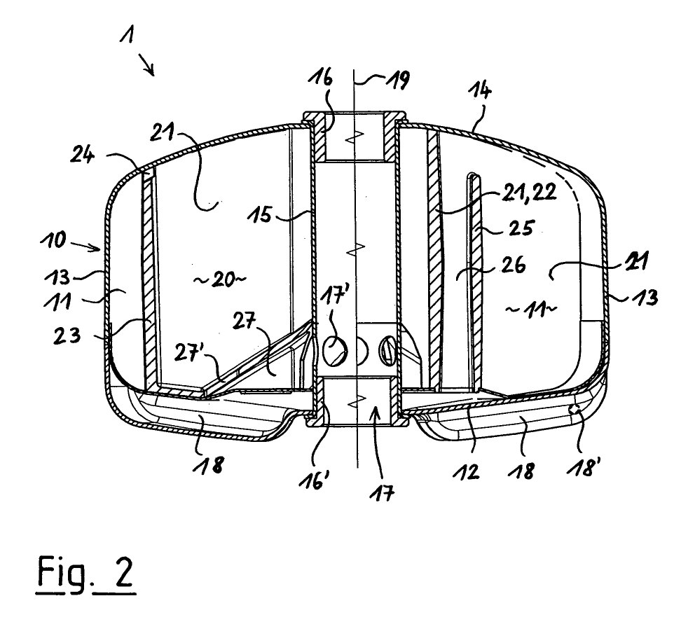

In the left-hand section of FIG. 2, the cross-section along line II-II shown in FIG. 1, the view extends through one of the spaces 20 and, in the right-hand section of FIG. 2, between two spaces 20 and through the interior region 11 of the rotor housing 10.

The rotational axis 19, about which the rotor 1 is rotatable as a whole, is arranged in the center of FIG. 2. The central tube 15 that is intended to supply the fluid to be purified extends concentrically with the rotational axis 19, with one plain bearing 16, 16′ being inserted each at the top and the bottom of said central tube. Above the lower plain bearing 16′, the central tube 15 is provided with several openings 17′ that are distributed around the circumference of said central tube, with one opening 17′ being assigned to each of the spaces 20. In a radially outward direction, each opening 17′ is initially followed by a fluid channel 27 that is separated from the pertinent space 20 by a partition wall. Each partition wall is provided with a passage 27′ through which the supplied fluid flows to a radially outward region of the pertinent space 20. The space 20 is each delimited by the walls 21, 22 of the wall pairs 2, as already illustrated by means of FIG. 1. One of the walls 21 is visible in the background of FIG. 2. In a radially outward direction, the space 20 is delimited by the front wall 23 that extends at a distance from the circumferential wall 13 of the rotor housing 10. The slot-shaped fluid transfer opening 24 that is, at its top, delimited by the upper wall 14 of the rotor housing 10, that is shown here, can be seen at the upper end of the front wall 23. The remaining interior region 11 of the rotor housing 10 is arranged in a radially outward direction from the front wall 23. In a downward direction, this is followed by a nozzle chamber 18 that is assigned to a propulsion nozzle 18′ not visible in the left-hand section of FIG. 2.

In its central region, the right-hand section of FIG. 2 also shows the central tube 15 with its openings 17′. The walls 21, 22 that are converging here, as illustrated in FIG. 1, are then intersected in a radially outward direction.

Still further in a radially outward direction, there follows the intermediate wall 25 that, together with the walls 21, 22, delimits the channel 26 for discharging the fluid from the interior region 11 of the rotor housing 10. At its top, the intermediate wall 25 ends at a distance from the upper wall 14 of the rotor housing 10.

Still further in a radially outward direction, the outside of one of the walls 21 of the wall pairs 2 is visible in the background. At its extreme outer edge, the rotor housing 10 is delimited by the circumferential wall 13. Also in the right-hand section of FIG. 2, a nozzle chamber 18 that is visible here from an outside view and that is provided with one of the propulsion nozzles 18′ on its rear side in FIG. 2 is arranged below the bottom 12 of the rotor housing 10.

While the rotor 1 is operated in a centrifuge, the fluid to be purified flows in from below through the fluid inlet 17. As can be seen from the left-hand section of FIG. 2, the fluid flows through the openings 17′ and, in a radially outward direction, through the fluid channels 27 and the passages 27′ and into the spaces 20. There, a first separation of dirt particles takes place at the radially inward surface of the front wall 23. The fluid that has been prepurified there flows via the radially outer fluid transfer opening 24 into the remaining interior region 11 of the rotor housing 10 from above, where dirt particles from the fluid are further settling on the inner surface of the circumferential wall 13.

Discharge of the fluid can be seen from the right-hand section of FIG. 2. The fluid flows from the interior region 11 of the rotor housing across the top edge of the intermediate wall 25 and into the channel 26 and then, in the latter, downwards through the bottom 12 of the rotor housing 10 into one of the nozzle chambers 18. From there, the pressurized fluid exits through the propulsion nozzles 18′, thus driving the rotor 1.

As illustrated in FIG. 2, the walls 21, 22, 23, 25 are formed such that they can be produced as a single-piece injection-molded part and can be inserted into the rotor housing 10 as an insert.

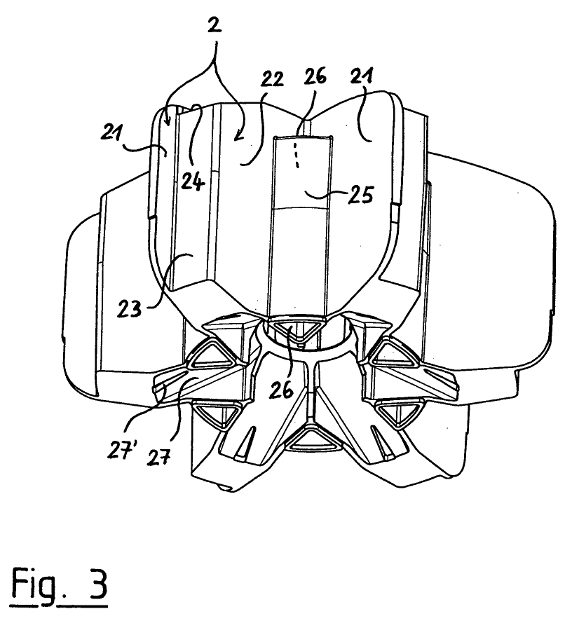

FIG. 3 shows the above mentioned insert in an inclined perspective from below without the rotor housing 10.

FIG. 3 shows the total of six wall pairs 2 each comprising one wall 21 and one wall 22, that extend in a radially outward direction from the center in the shape of a star and that each enclose a space 20 that is not visible here. In a radially outward direction, the spaces 20 are each almost completely closed by the front wall 23. The fluid transfer openings 24 are formed at the top edge of the front walls 23 and the adjacent areas of the walls 22, here simply by a small shortening of the front wall 23 and the area of the wall 22 that is adjacent thereto. Together with the rotor housing 10 that is not shown here, that is to say together with the upper wall 14 of said rotor housing, this results in a gap-shaped fluid transfer opening 24 from each space 20 into the remaining interior region 11 of the rotor housing 10.

The fluid channels 27 that are running from a radially inner region to the outside and are connected to the spaces 20 via passages 27′ are visible at the bottom side of the component shown in FIG. 3.

One of the intermediate walls 25 that each delimit the channels 26 together with the walls 21, 22 is each arranged between two neighboring walls 21, 22 of two neighboring wall pairs 2. The channels 26 are running downwards, where they are connected to the nozzle chambers 18 that are not shown in FIG. 3.

Finally, FIG. 3 clearly illustrates that the walls 21 of each wall pair 2 extend in an outward direction beyond the front walls 23 and only end at the circumferential wall 13 of the rotor housing 10, as shown in FIGS. 1 and 2.

The component shown in FIG. 3 can preferably be manufactured as a single-piece injection-molded part, thus permitting cost-effective large-scale production. The material may be plastic or light metal.

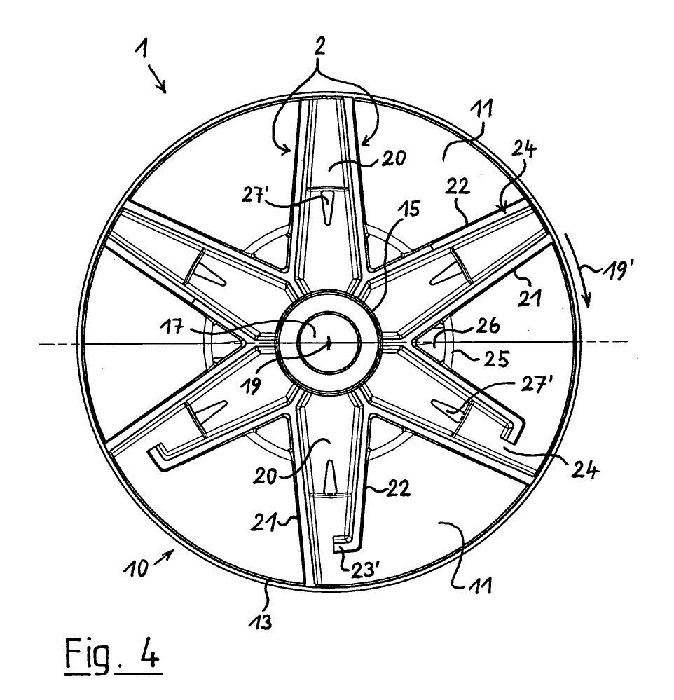

FIG. 4 shows two further executive forms of the rotor 1 in same representation as in FIG. 1, wherein one embodiment of the rotor 1 is shown in the lower half of FIG. 4 and one embodiment of the rotor 1 is shown in the upper half of FIG. 4.

A characteristic feature of the embodiment of the rotor 1 as shown in the lower half of FIG. 4 is that each wall 21 of the wall pairs 2 extends to the circumferential wall 13 of the rotor housing 10. The respectively other wall 22 of each wall pair 2 ends at a distance from the circumferential wall 13 and is connected to and formed integrally with a section of the front wall 23′ that extends in circumferential direction. Here as well, the walls 21, 22 of the wall pairs 2 each enclose a gap-shaped space 20 that extends from the radially inner region of the rotor 1 in a radially outward direction to a point shortly in front of the circumferential wall 13. An intermediate space that forms a fluid transfer opening 24 permitting the fluid to be purified to be transferred from the respective space 20 into the remaining interior region 11 of the rotor housing 10 is left clear between the circumferentially arranged front face of each front wall section 23′ and the pertinent wall 21. The front walls 23′ are positioned a distance from the circumferential wall 13 which is a small fraction, that is, less than ½, of the radium of the rotor housing 10.

The upper half of FIG. 4 shows as a further embodiment of the rotor 1, an embodiment in which the two walls 21, 22 of each wall pair 2 each extend to the circumferential wall 13 of the rotor housing 10. Hence, the spaces 20 in the radially outer region each extend to a point immediately adjacent to the circumferential wall 13 which is within a small fraction, that is, less than ½, of the radius of the rotor housing 10 from the circumferential wall 13. Here, fluid transfer openings 24 that are formed in the shape of slots on the top edge of the walls 22 are provided to allow fluid to be transferred from the spaces 20 into the remaining interior region 11 of the rotor housing 10. Preferably, the slots that form the fluid transfer openings 24 are designed with a height that is decreasing from the exterior to the interior in a radial direction. While it is true that the fluid transfer opening 24 is shortened by the settled dirt particles as the settlement of dirt particles at the internal perimeter of the circumferential wall 13 increases, the decreasing cross-section ensures that the flow rate of the fluid increases and, thus, that the flow path is always clear for the fluid to flow through.

In the two executive forms of the rotor 1 illustrated in FIG. 4, the fluid to be purified is also supplied through a fluid inlet 17 in a central tube 15, with said fluid inlet being connected to the spaces 20 via fluid channels that are concealed here and via the visible passages 27′. Here as well, the fluid is discharged from the interior region 11 of the rotor housing 10 by channels 26 that are formed in the same way as in the executive example according to FIG. 1.

In the executive examples of the rotor 1 according to FIG. 4, the settlement of dirt particles takes place, in substance, on the inner surface of the circumferential wall 13. A partial settlement of dirt can, in addition, be achieved on additional surfaces. In the case of the rotor 1 according to the lower half of FIG. 4, the radially inward surfaces of the front wall sections 23′ are provided as additional settlement surfaces; in the case of the rotor 1 according to the upper half of FIG. 4, the radially inward surface areas of the circumferential wall 13 that are arranged within the spaces 20 are provided for the settlement of dirt particles.

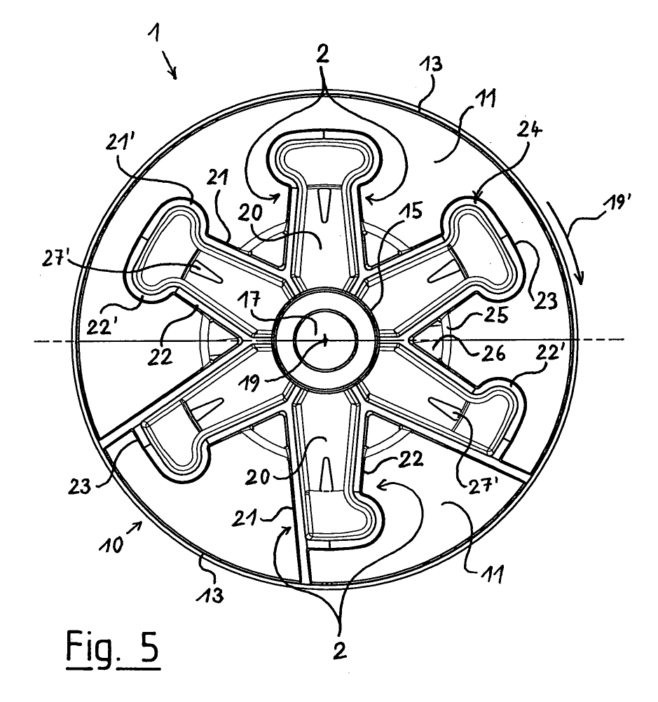

FIG. 5 of the drawing shows two further embodiments of the rotor 1, with the lower half and the upper half of FIG. 5 each showing one example.

A characteristic feature of the example according to the lower half of FIG. 5 is that the wall 21 of the wall pairs 2 each extends to the circumferential wall 13 in a straight line and in a generally radially outward direction. The other wall 22 each comprises a curved projection 22′ that extends in a circumferential direction. These curved projections 22′ ensure that the radially outer region of the spaces 20 is increased, whereby an increased volume is provided for the settlement of dirt particles.

For the embodiment of the rotor 1 according to the upper half of FIG. 5, it is substantially that, here, both walls 21, 22 of each wall pair 2 are formed to comprise a radially outer curved projection 21′, 22′. The curved projections 21′, 22′ each face away from each other and extend in circumferential direction. This creates a volume in the radially outer regions of the spaces 20 that is still further increased in comparison with the executive example shown in the lower half of FIG. 5. Thus, an accordingly larger surface and a larger volume are created for the settlement of dirt particles on the radially inner side of the front walls 23.

Here, the fluid to be purified is supplied through the fluid inlet 17 in the central tube 15 in the same manner as described above. From said central tube, the fluid flows through the concealed fluid channels 27 and the passages 27′ and enters into the spaces 20. From there, the fluid can flow via fluid transfer openings 24′ having the form of slots that are provided at the top edge of the walls 22 of the walls 2 and the front walls 23 and then into the remaining interior region of the rotor housing 10. From there, the fluid flows through the channels 26 behind the intermediate walls 25 in a downward direction to the pertinent propulsion nozzles that are not visible in FIG. 5.

In both embodiments shown in FIG. 5, the front walls 23 are positioned such that the spaces 20 end within a small fraction, that is, less than ½, of the radius of the rotor housing 10 from the circumferential wall 13.

In the four executive forms of the rotor 1 according to FIGS. 4 and 5, the walls 21, 22 of the wall pairs 2, the front walls 23 or the front wall sections 23′ and the intermediate walls 25 can be manufactured as a single-piece injection-molded part, thus permitting, here as well, the production of a single-piece insert that can be installed in the rotor housing 10 as a whole.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

The embodiments of the invention in which an exclusive property or privilege is claimed are defined as follows:

1. A rotor for a centrifuge for the separation of solid particles from a fluid, with a rotor housing defining an interior region that is rotatable about a central rotational axis and cylindrical in its basic shape, wherein said rotor housing comprises a fluid inlet, a fluid outlet with at least one propulsion nozzle for driving the rotor by means of the fluid flowing through it, and walls that are provided in and partition the interior region of the rotor, comprising, several wall pairs spaced apart from each other in a circumferential direction provided in the interior rotor region, comprising walls that are also spaced apart from each other in a circumferential direction and enclose between them a space having the approximate shape of a gap, with said space radially extending in an outward direction from a central area that is connected to the fluid inlet and ending within a small fraction of a radius of the rotor housing from a circumferential wall of the rotor housing, thus permitting fluid to enter into the remaining interior rotor region.

2. The rotor according to claim 1, wherein the walls forming the wall pairs extend along planes that are, in substance, arranged parallel to the rotational axis and extend in a substantially radially outward direction.

3. The rotor according to claim 1, wherein the spaces having the shape of a gap form a rotationally symmetric star shape, as seen from a cross-sectional view of the rotor perpendicular to the rotational axis.

4. The rotor according to claim 3, wherein the star shape is formed to comprise three to eight arms.

5. The rotor according to claim 3, wherein the star shape is formed to comprise four to six arms.

6. The rotor according to claim 1, wherein at least one of the two walls of each wall pair is formed to comprise a front wall section that forms a partial and radially outer boundary of the respectively enclosed gap-shaped space and extends in a substantially circumferential direction.

7. The rotor according to claim 6, wherein each front wall section partially delimits the space in the direction of the circumference of the rotor.

8. The rotor according to claim 6, wherein each front wall section partially delimits the space in the direction of the axis of the rotor.

9. The rotor according to claim 1, wherein the two walls of each wall pair are connected to each other via a front wall that extends in a substantially circumferential direction and forms a radially outer boundary of the respectively enclosed gap-shaped space that ends at a distance from the circumferential wall and that a fluid transfer opening is provided in at least one of the front wall, and one wall of the wall pair.

10. The rotor according to claim 6, wherein the radial distance of the front wall section from the rotational axis of the rotor comprises about 70 to 90 percent of the rotor radius.

11. The rotor according to claim 9, wherein the radial distance of the front wall for the rotational axis of the rotor comprises about 70 to 90 percent of the rotor radius.

12. The rotor according to claim 1, wherein one wall of each wall pair each extends to an internal perimeter of the circumferential wall of the rotor housing.

13. The rotor according to claim 12, wherein the rotor is arranged to rotate in a first direction about the rotational axis, and the one wall extending to the internal perimeter of the circumferential wall of the rotor housing is the one wall of each pair that is positioned in the direction of rotation of the rotor relative to the other wall of the pair.

14. The rotor according to claim 1, wherein the two walls of each wall pair extend to an internal perimeter of the circumferential wall of the rotor housing and a fluid transfer opening is provided in at least one of the walls of the wall pair.

15. The rotor according to claim 9, wherein each fluid transfer opening extends as a slot across a radial region of at least one wall of the wall pair and front wall.

16. The rotor according to claim 15, wherein a width of the slot forming the fluid transfer opening decreases in a radial inward direction.

17. The rotor according to claim 1, wherein the walls of each wall pair converge in a radially outward direction.

18. The rotor according to claim 1, wherein the walls of each wall pair are each aligned in parallel with one another in a radially outward direction.

19. The rotor according to claim 1, wherein the walls of each wall pair diverge in a radially outward direction.

20. The rotor according to claim 9, the walls of each wall pair, at a radially outer part thereof, each comprise a lateral curved projection each extending away from the other wall of the wall pair in a circumferential direction to increase the size of the front wall as measured in circumferential direction.

21. The rotor according to claim 1, wherein said rotor comprises a central tube extending concentrically with said rotational axis, wherein said central tube is provided as a fluid inlet to the interior rotor region and is in fluid communication with the spaces respectively enclosed by the wall pairs via apertures.

22. The rotor according to claim 21, wherein a fluid channel is formed inside a lower area of each space, which extends from the apertures into a radially central to outer area of each space.

23. The rotor according to claim 1, wherein the wall pairs, as viewed in the direction of the axis of the rotor, each extend across at least half of the rotor's axial internal height and, at the most, across the rotor's total axial internal height.

24. The rotor according to claim 1, wherein a plurality of intermediate wall search extend in a substantially circumferential direction and end at a distance from an inner side of an upper wall of the rotor housing and are each arranged between two walls of two neighboring wall pairs, wherein said two walls face each other, and said intermediate walls, together with the walls of the wall pairs, form radially inward positioned channels that run to the fluid outlet in the direction of the rotational axis of the rotor.

25. The rotor according to claims 9, wherein a flow guide wall is provided next to each fluid transfer opening on the outside of each associated wall of the wall pair, wherein the flow of fluid from the fluid transfer opening is directed along said flow guide wall in one of a radially outward direction and in a radially outward and axially downward direction.

26. The rotor according to claim 1, wherein a diameter of the rotor exceeds a height of the rotor.

27. The rotor according to claim 1, wherein at least the several wall pairs are made of a single-piece part made of one of injection-molded plastic and light metal, and said part is inserted in the rotor housing as an insert.

28. The rotor according to claim 1, wherein the rotor housing comprises one injection-molded lower housing part and one injection-molded upper housing part and a first part of the walls of the several wall pairs is formed integrally with the lower housing part and a second part of the walls of the several wall pairs is formed integrally with the upper housing part.

29. The rotor according to claim 1, wherein the rotor housing consists of only one injection-molded lower housing part, only one interior housing part and only one upper housing part and the walls of the several wall pairs are at least partially formed integrally with one of the lower housing part, the interior housing part and the upper housing part.
